(19) United States
(12) Patent Application Publication
(10) Pub. No.: US 2012/0255585 A1
(43) Pub. Date: Oct. 11, 2012

(54) Portable System for Directing Pressurized Air Upon a Surface

(76) Inventor: Mark Kowalczyk, Amsterdam, NY (US)

(21) Appl. No.: 13/425,778

(22) Filed: Mar. 21, 2012

Related U.S. Application Data
(60) Provisional application No. 61/472,909, filed on Apr. 7, 2011.

(51) Int. Cl. B08B 5/02; F26B 21/00

(52) U.S. Cl. 134/37; 15/405; 34/523

(57) ABSTRACT

A portable system for treating, for example, cleaning and/or drying, surfaces, including both indoor and outdoor surfaces, is provided. The system includes a pressurized air outlet assembly, or “air knife” assembly, coupled to a source of pressurized air, for example, a blower, a fan, or a turbine. The air knife assembly concentrates a high volume exhaust flow of air into a high velocity, high temperature, and/or high pressure air stream directed at a target surface. The air stream can be angularly varied to propel water, snow, debris, and other particulate from the target surface, for example, a path or roadway being cleaned or dried. The air knife blade assembly is substantially long enough to allow a single lane of roadway or runway to be dried and cleaned in one pass, but can also be shortened to allow treatment of narrower paths.

### CROSS-REFERENCE TO RELATED APPLICATIONS

This application claims priority from pending U.S. Provisional Patent Application 61/472,909, filed on Apr. 7, 2011, the disclosure of which is included by reference herein in its entirety.

### BACKGROUND OF THE INVENTION

1. Field of the Invention

The present invention relates to improved systems and methods for directing a flow of pressurized air upon a surface, for example, to facilitate, cleaning and drying surfaces faster and more efficiently. More specifically, embodiments of the present invention focus on apparatus and methods for removing water, snow, debris, and particulates, among other things, from surfaces.

2. Description of Related Art

Many instances arise where there is a need for clean, dry, and particulate-free surfaces, for example, outdoor surfaces, such as, surfaces used for vehicles, aircraft, athletes, and pedestrians. For transportation purposes there is a need to have roads, sidewalks, and airplane runways, among other surfaces, free of debris, and preferably dry. This need is further amplified for activities such as auto racing where drag strips, track surfaces, and/or pit lanes are periodically cleared of tire damaging debris between heats, and oval tracks are often dried to allow racing to take place and/or resume after rain or spills.

On aircraft carriers and runways, the flight deck or runway typically undergoes a foreign object damage sweep prior to any flight operations. For maintenance activities on paved or concrete surfaces, the surface being treated typically must be clean and dry prior to paving, seal coating, painting, and/or filling of holes and cracks. During certain repaving or grooving activities, the original surface is typically milled away, leaving considerable remnants behind which must be removed prior to applying the new surface. For sporting events, play is often delayed while the playing surface is cleared and/or dried.

Surface cleaning and drying methods are known in prior art. The majority of known methods apply in manufacturing environments, usually on conveyor or production lines. Some devices have been developed to specifically address racetrack drying. However, the most commonly used devices for racetrack drying and cleaning typically do not have the capability of dispersing puddles of water from the surface.

For maintenance activities on paved or concrete surfaces, typically large quantities of air are often blown over the surface prior to seal coating, painting, and/or filling of cracks. These activities are often done by hand, using hand-held “leaf blower”-type devices, and/or air wands attached by hoses to large compressors. During certain repaving activities, large brushes are utilized. Clearing of grass and turf surfaces is typically accomplished by use of high volume air blowers, either mounted to machines or smaller versions that are hand-held or pushed. Outdoor skating rinks and tracks are often shoveled and swept by hand. Sidewalks may typically be cleared of snow with snow blowers; however, often a layer of snow and/ice may be left that can create a slip hazard to pedestrians. Such slippery surfaces are often treated with chemicals, typically salts, that—though effective—can introduce undesirable chemicals to the environment.

Other prior art method and devices for treating surfaces are described in U.S. Pat. No. 6,286,228; U.S. Pat. No. 6,189,179; U.S. Pat. No. 6,260,231; U.S. Pat. No. 6,990,751; U.S. Pat. No. 6,146,092; U.S. Pat. No. 7,520,314; U.S. Published Application 2010/0120350 A1; U.S. Pat. No. 7,216,396; U.S. Pat. No. 6,073,305; U.S. Pat. No. 5,673,457; and U.S. Pat. No. 3,999,243, among others.

Aspects of the present invention overcome the disadvantage of these and other prior art devices and methods.

### SUMMARY OF THE INVENTION

Given the concepts and methods of the prior art referred to above, the present invention offers improved devices, systems, and methods for directing a flow of pressurized air upon surfaces, for example, to facilitate cleaning and/or drying of the-surfaces, for example, outdoor surfaces. One intent of the present invention, which will be described in full detail below, is to provide improved devices, systems, and methods that employ novel methods of function, scale, application, and manufacture which have not been disclosed in the prior art.

Some embodiment of the present invention may utilize air knives as part of an integrated system to direct a high velocity, high temperature, and/or high pressure gas, typically air, in close proximity to the desired or target surface in order to facilitate drying and/or particulate and debris removal. It is to be understood that, as described herein, when the expression “air knife” or “air knife blade” is used, the expression is not limited to air knives, as known in the art, but refers to any device comprising a cavity or plenum containing pressurized air and one or more holes or slots, for example, a plurality of holes, arrayed in a generally longitudinal direction, or one or more continuous slots, for example, longitudinal slots, through which the pressurized air is discharged, for example, upon a surface. In one aspect, an air knife assembly, for example, having a variable angle of attack, is coupled to an air pressurizing device, for example, a blower, a fan, or a turbine, and the like. The air knife assembly concentrates the high volume exhaust flow of air into an accelerated stream directed at the contact surface,for example precisely directed. The air knife may be adjusted angularly along multiple axes to drive the water, snow, debris, and particulates off to the side of the particular path being cleaned and/or dried. The air knife assembly may be modularly sized such that it can vary in length based on the application. The air knife assembly may be substantially long enough to allow a single lane of traffic or runway to be dried and/or cleaned, for example, in one pass, but can also be shortened to allow use for push-type applications to facilitate use on smaller driveways and sidewalks for seal coating applications, or sports playing surfaces, and the like.

One embodiment of the invention is a portable system for directing a flow of pressurized air upon a surface, the portable system comprising or including a source of pressurized air; and a pressurized air outlet operatively connected to the source of pressurized air, the pressurized air outlet adapted to direct a flow of the pressurized air upon the surface while the pressurized air outlet translates over the surface. The source of pressurized air may comprise a fan, a blower, or a turbine, among others. The source of pressurized air may be powered by, for example, an electric motor, a hydraulic pump or motor, or a gasoline or diesel engine. In one aspect, the pressurized air outlet may comprise an air knife. In another aspect, the pressurized air outlet may be an adjustable outlet. In another aspect, the invention may further comprise a means for moving the portable system, for example, a trailer, a tractor, a skid steer, a mower, a utility vehicle (UTV), an all terrain vehicle (ATV), or a truck, among other vehicles.

Another embodiment of the invention is a method of treating a surface with pressurized air, the method including or comprising: directing a flow of pressured air from a pressurized air outlet while the pressurized air outlet is translated over the surface. For example, treating may be cleaning, clearing, heating, and/or drying. In another aspect, the method may further comprise varying a dimension of the pressurized air outlet, for example, to vary the velocity, temperature, and/or pressure of the pressurized air discharged from the outlet.

A further aspect of the invention is a portable surface treating system comprising or including a source of pressurized air mounted to a frame, the source having an outlet discharging pressured air; at least one conduit having a first end operatively connected to the outlet and a second end; a pressurized air outlet assembly having an inlet operatively connected to the second end of the at least one conduit source of pressurized air, a plenum in fluid communication with the inlet, and at least one outlet in fluid communion with the plenum adapted to discharge a flow of pressurized air upon the surface to displace any undesirable material from the surface; and a mechanism adapted to vary an orientation of the pressurized outlet assembly. In one aspect, the system may further include a mechanism adapted to vary a size of the at least one outlet. In another aspect, the source of pressurized air may be a fan, a blower, or a turbine. The treating performed by the system may be cleaning, clearing, drying, or heating of the surface.

Another aspect of the invention may capture the airflow, for example, the high volume flow, from a blower, fan, or turbine and direct and concentrate it in a precise shape and location to aid in both drying and particulate removal.

Still another aspect of the present invention may utilize the laws of fluid flow and physics to manipulate the output of the source of pressurized air, for example, a blower, fan, or turbine, to increase the velocity, temperature, and/or pressure of the flow of air, for example, the “knife jet” of air, and be utilized for cleaning and/or drying the desired or target surface. In one aspect, a temperature increase may be produced by the compression of the gas stream and this temperature increase may have a direct effect on the amount of evaporation of moisture during the surface treatment, for example, drying.

Other aspects of the present invention may decrease energy and/or fuel consumption, for example, greatly decrease energy and/or fuel consumption, while increasing operating efficiency over similar systems and methods presented in the prior art. In one aspect, energy and/or fuel consumption maybe decreased at least about 20%; in another aspect, energy and/or fuel consumption maybe decreased at least about 40%, or more.

Other aspects of the present invention may provide greater control to the direction, volume, temperature, and/or pressure of the gas flow, for example, air flow, being supplied to facilitate drying and/or cleaning. For example, in one aspect, the direction of air flow may be controlled by means of multi-axis controller, for example, the direction of the flow of air may be precisely controlled on four or more axes, for instance, six axes, that is, six directional axes.

Still further aspects of the present invention may increase the rate of drying and/or debris removal by employing an angular trajectory at the point of contact with the target surface, for example, by forcing the moisture, ice, snow, dirt, particulate, and/or debris off to the side of the particular area, for example, a lane or roadway, being treated.

Aspects of the present invention may eliminate standing water, puddles of water, snow, and/or ice from remaining on the target surface after treatment as a result of the deployment of aspects of the invention, for example, the air knife concept, over previous methods described in the prior art.

Aspects of the present invention may enable the cleaning and drying of grooves and/or cracks in the target surface, for example, in paved surfaces or concrete surfaces, being prepared for application of seal coating, paint, and/or crack filler. In one aspect, the surface may be an asphalt paved surface or a concrete surface containing grooves, for instance, previously milled grooves.

Aspects of the present invention may used to treat ice surfaces, for example, ice skating and/or racing surfaces, such as, hockey rinks or racing ovals. Aspects of the invention may be used to melt or remove snow and/or ice shavings from ice skating and/or racing surfaces. Aspects of the invention may also be used to treat or refinish ice skating surfaces by employing a temperature rise of the outlet air from the air knife assembly to melt the top of the surface whereby subsequent remelting of the surface provides a smoother ice surface, for instance, having reduced roughness and reduced blemishes in the ice surface.

Aspects of the present invention may aid in the removal of foreign or undesirable objects and/or from the flight decks of aircraft carriers and/or from runways of airfields and airports.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of one aspect of the invention, for example, when an aspect of the invention is towed behind a vehicle (shown in phantom).

FIG. 2 is a front perspective view, partially exploded, of another aspect of the invention, for example, when an aspect of the invention is mounted to the front of a vehicle, such as, a tractor (not shown).

FIG. 3 is a rear perspective view, partially exploded, of the aspect of the invention shown in FIG. 2.

FIG. 4 is an elevation view of a detail of the aspect of the invention shown in FIG. 2 as viewed along view line 4 in FIG. 2.

FIG. 5 is a perspective view of another aspect of the invention, for example, when an aspect of the invention is mounted to the rear of a vehicle, such as, a tractor (shown in phantom).

FIG. 5A is a partial perspective view of an air knife mounting arrangement according to another aspect of the invention.

FIGS. 6 through 12 are elevation views illustrating various combinations of aspects of the invention and vehicles to which the aspects may be mounted.

FIG. 13 is a perspective view of another aspect of the invention that can be used for “walk behind” applications, for example, for treating driveways, sidewalks, and/or sporting surfaces.

In these drawings, like reference characters may designate the same or similar parts or components throughout.

### DETAILED DESCRIPTION OF ASPECTS OF THE INVENTION

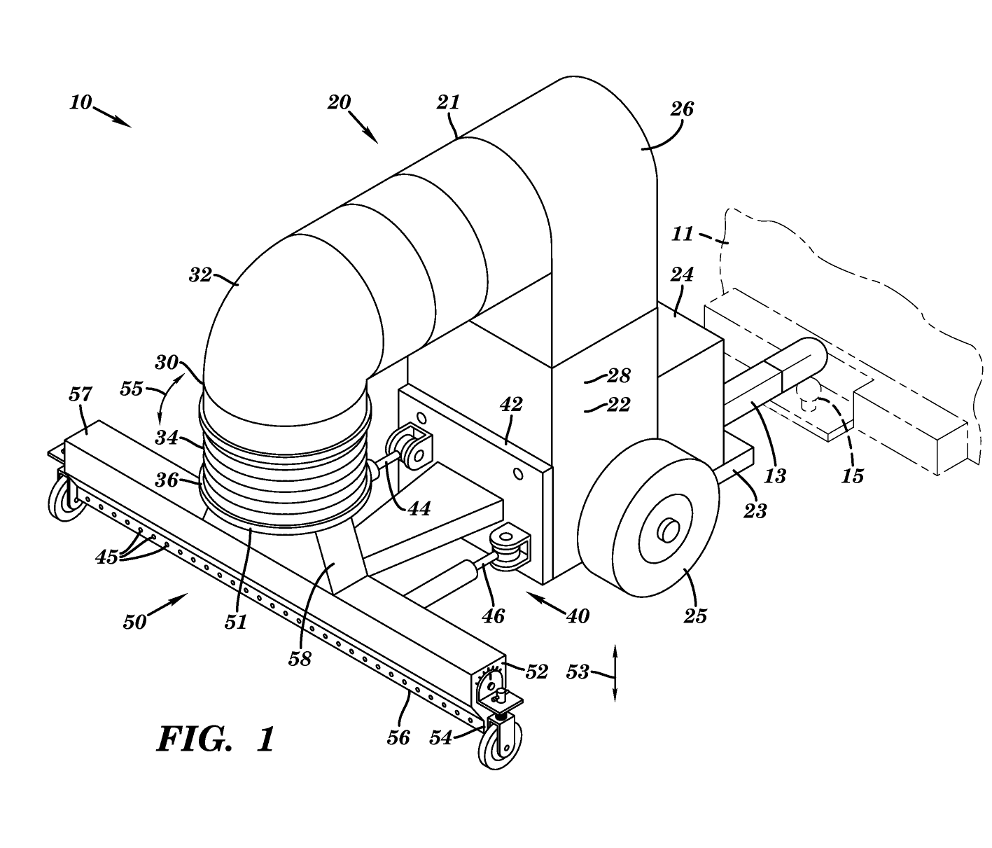

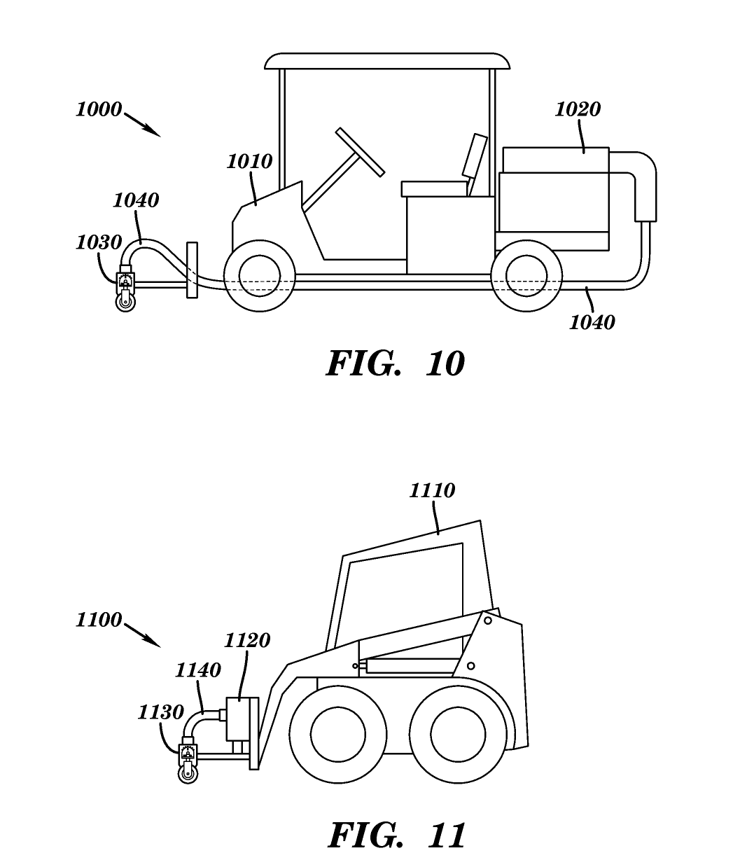

FIG. 1 is a perspective view of one aspect of the invention, for example, when system 10 according on an aspect of the invention is adapted to be towed behind a vehicle 11 (partially shown in phantom), such as, a pick up truck. System 10 shown in FIG. 1 comprises an improvement over any prior art surface cleaning and/or drying devices. System 10 and related aspects disclosed herein may be used for treating indoor and/or outdoor surfaces. As shown in FIG. 10, in one aspect, system 10 is adapted to be towed behind any vehicle 11, for example, a vehicle equipped with a conventional hitch 15. System 10 includes a pressurized air outlet assembly 50, for example, an air knife assembly or air knife blade assembly, operatively connected to a source of pressurized air 20, for example, an air supply unit, having an outlet 21. The pressurized air outlet assembly 50 having an inlet 51, an inlet manifold 58, and an outlet 56 may be operatively connected to the source of pressurized air 20 for example, operatively connected via a flexible coupling assembly 30. Though the source of pressurized air 20 may be provided by any commercially available device, in the aspect of the invention shown in FIG. 1, the source of pressurized air 20 may include a frame/wheel assembly 22 including frame 23 having wheels 25 adapted to support an engine or motor 24 and an air pressurizer 26, such as, a fan, a blower, a turbine, or a combination thereof. As shown in FIG. 1, system 10 may be mounted to vehicle 11 by one or more conventional struts or beams 13, for example, adapted to engage a trailer hitch 15.

Throughout this discussion, the pressurized air outlet assembly 50 may be referred to as an “air knife 50” or an “air knife assembly 50” for ease of description. However, it is to be understood that the use of the term “air knife” does not limit the pressurized air outlet assembly 50 to an air knife. According to aspects of the invention the pressurized air outlet assembly 50 may comprise an air knife as known in the art, or any device or structure that provides the function of an air knife. For example, in one aspect, pressurized air outlet assembly 50 may comprise any device or structure that is adapted to receive a flow of gas, typically, air, and direct the flow of gas, for instance, at a higher velocity than received, upon a surface.

According to one aspect, the pressure of the gas prior to leaving the pressurized air outlet assembly or air knife 50 may be at least 5 pounds per square inch-gauge [psig], and may be at least 10 psig, or 100 psig.

In one aspect of the invention, the pressurized air outlet assembly or air knife 50 may be adapted to discharge a heated stream of gas, for example, heated air. In one aspect, the heated stream of gas may comprise a temperature of at least 1 degree F. above the prevailing ambient temperature, for example, above ambient “room temperature” of about 68 degrees F. However, the temperature rise of the gas stream may be greater than whatever the prevailing ambient temperature is, for example, 20 degrees F., 40 degrees F., 80 degrees F., or even 100 degrees F. In one aspect, the heated gas stream may have a temperature of at least 5 degrees F. above the prevailing ambient temperature, but may be at least 10 degrees F., 20 degrees F., or even 50 degrees F. greater than the prevailing ambient temperature. In one aspect, the temperate of the gas stream exiting the air knife assembly 50 may be at least 100 degrees F.; in another aspect, at least 150 degrees F.; or even, 200 degrees F. or higher.

In one aspect of the invention, the temperature of the gas stream may be raised by direct heating, for example, from an electric heating element or from contact with an engine housing or an engine exhaust gas. In one aspect, engine exhaust gas may be introduced to the gas stream before, during, or after the gas stream is discharged from pressurized air outlet assembly 50. In another aspect of the invention, the gas stream may be heated without direct heating but through heating related to the compression of the gas, for example, compression heating by the source of pressurized air or from restrictions in the conduits and piping, or from constrictions in the housing and/or outlet of the air knife assembly 50.

The velocity of the gas discharged from the pressurized air outlet assembly 50, for instance, the velocity of the gas stream passing through outlet 56, may range from about 10,000 feet per minute [FPM] to about 80,000 FPM, but is typically in the range of about 20,000 FPM to about 60,000 FPM.

According to one aspect of the present invention, the outlet 56 of the pressurized air outlet assembly 50 directs a pressurized flow of air on to the surface being treated, for example, outlet 56 directs air whereby the air may impinge the surface being cleaned and/or dried in a direction substantially perpendicular to the surface being treated. In one aspect, the direction of the flow of air from the outlet 56 impinges the surface at an angle of about 90 degrees, plus or minus 5 degrees. In another aspect, the direction of the flow of air from the outlet 56 impinges the surface at an angle of about 90 degrees, plus or minus 15 degrees, or plus or minus 30 degrees.

One advantage of aspects of the present invention is the coupling of the pressurized air outlet assembly 50, or air knife assembly, to the outlet 21 of the source of pressurized air 20, such as, the outlet of a blower, fan, or turbine. This innovation of one aspect of the invention makes the system 10 much more effective and efficient by capturing the airflow and directing it into a precise stream. Due to the resulting restriction on the fluid (for example, air) flow through the outlet 56, for example, a slot, in, for example, the air knife 50, the velocity, the pressure, and/or the temperature in the air flow rises. This temperature rise in the air flow can be controlled and used to assist in evaporation drying.

In one aspect, a flexible coupling assembly 30 may be used to direct the air flow from the outlet 21 of the source of pressurized air 20 to the inlet 51 of air outlet assembly 50. According to aspects of the invention, the flexible coupling assembly 30 may serve two purposes. First, the coupling assembly may typically include one or more elbows 32 that transmit the output of the source of pressurized air 20 to the inlet 51 of the manifold 58 of the air outlet assembly 50 via a flex hose 34. The flexibility of flex hose 34 allows for the vertical displacement or translation of the air knife assembly 50, as indicated by double arrow 53, without damaging and/or deflecting flexible coupling assembly 30 and/or source of pressurized air 20. Second, flexible coupling assembly 30 may include one or more rotatable unions 36 positioned along flexible coupling assembly 30. Rotatable unions 36 allow for the angular rotation of the air knife assembly 50, as indicated by double arrow 55, without damaging and/or deflecting flexible coupling assembly 30 and/or source of pressurized air 20.

The manifold 58 of pressurized air outlet assembly 50 is adapted to receive a flow of gas, for example, air, from the source of pressurized air 20, for example, via flexible coupling assembly 30, and direct the flow of the air to housing 52 of air knife assembly 50. Housing 52 may include a hollow internal cavity or plenum 57 and a transition 54 between the plenum 57 and the outlet 56. Manifold 58, plenum 57, and/or transition 54 may include one or more internal baffles (not shown) to assist in directing the flow of gas.

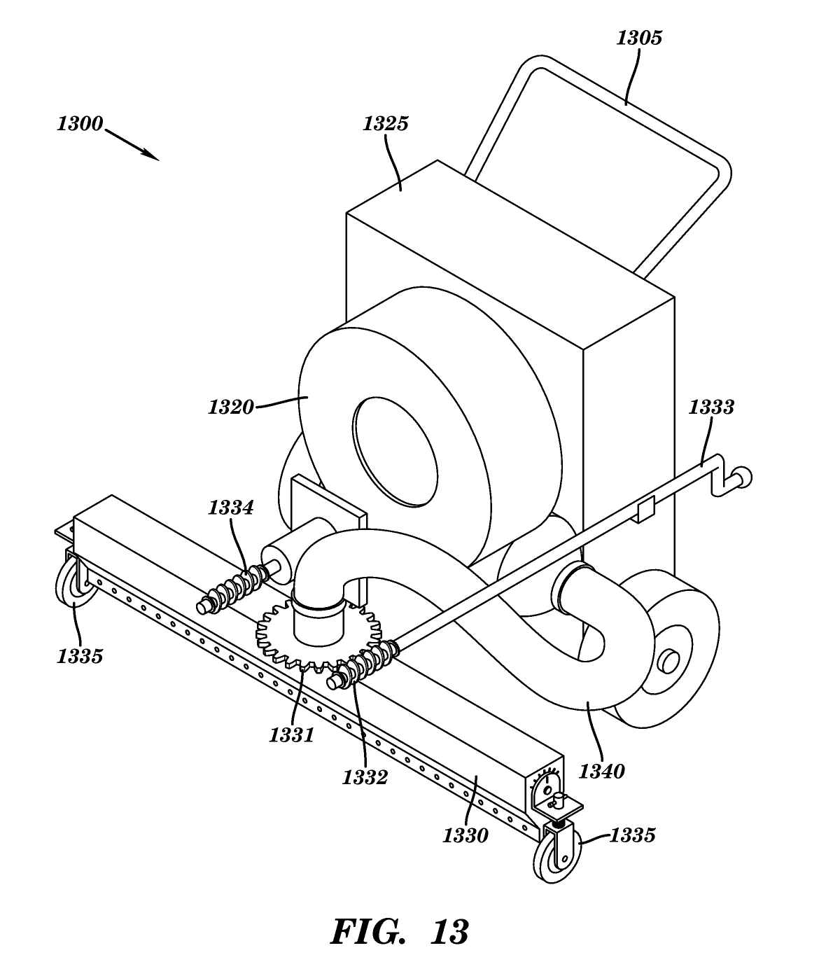

The pressurized air outlet assembly housing 52, for example, the air knife housing, and outlet or outlets 56 may be substantially long enough to allow, for example, a single lane of traffic or runway to be dried and cleaned in one pass. In one aspect, housing 52 may be about 5 feet to about 20 feet in length, for example, typically, between about 6 feet to about 12 feet in length. However, housing 52 and outlet or outlets 56 may also be shortened to allow adaptation for use smaller applications, for example, in walk-behind or push-type applications. Such shorter housings 52 may be provided in order to facilitate use of aspects of the invention on, for example, driveways, sidewalks, and/or sporting surfaces (as shown, for example, in FIG. 13). In another aspect, housing 52 may be about 1 foot to about 6 feet in length, for example, typically, between about 3 feet to about 4 feet in length.

In one aspect of the invention, the outlet 56 of the pressurized air outlet assembly 50, for example, an air knife, may comprise one or more slots or holes, for example, rectangular slots, or circular, rectangular, or square holes. In one aspect, outlet 56 may comprise one or more orifices, that is, specially designed openings that provide a desired volume of flow, velocity of flow, direction of flow, and/or temperature of flow. In one aspect, the one or more outlets 56 may be variable or adjustable, for example, outlet 56 may include a plurality of adjusting threaded fasteners 45, for example, screws or bolts, that are adapted to vary the width of outlet 56 when fasteners 45 are rotated. In one aspect, outlet-housing 52 with one or more outlets 56 may be designed to maximize the output of the fan/blower/turbine assembly 26, for example, by varying the geometry of the outlet 56 or knife opening. The pressurized air outlet assembly 50 or air knife may be precisely tuned to optimize performance to specific operating conditions. For example, the adjustable outlet 56 may be varied to optimize performance.

In one aspect, in order to direct the force of the air to the target surface being treated, for example, cleaned and/or dried, the pressurized air outlet or air knife assembly 50 may be fitted with a positioning unit assembly 40. Positioning unit assembly 40 is adapted to support and manipulate pressurized air outlet assembly 50. For example, positioning unit assembly 40 may be mounted to frame/wheel assembly 22. Positioning unit assembly 40 may include a positioning unit frame 42 adapted to connect the air knife assembly 50 and the air supply unit 20. For example, the frame 42 may be mounted to frame/wheel assembly 22 and be operatively connected to the pressurized air outlet 50 via one or more, or two or more, struts or supports 44, 46. In one aspect, struts or supports 44, 46 may comprise variable struts or supports, for example, having one or more hydraulic or pneumatic cylinders.

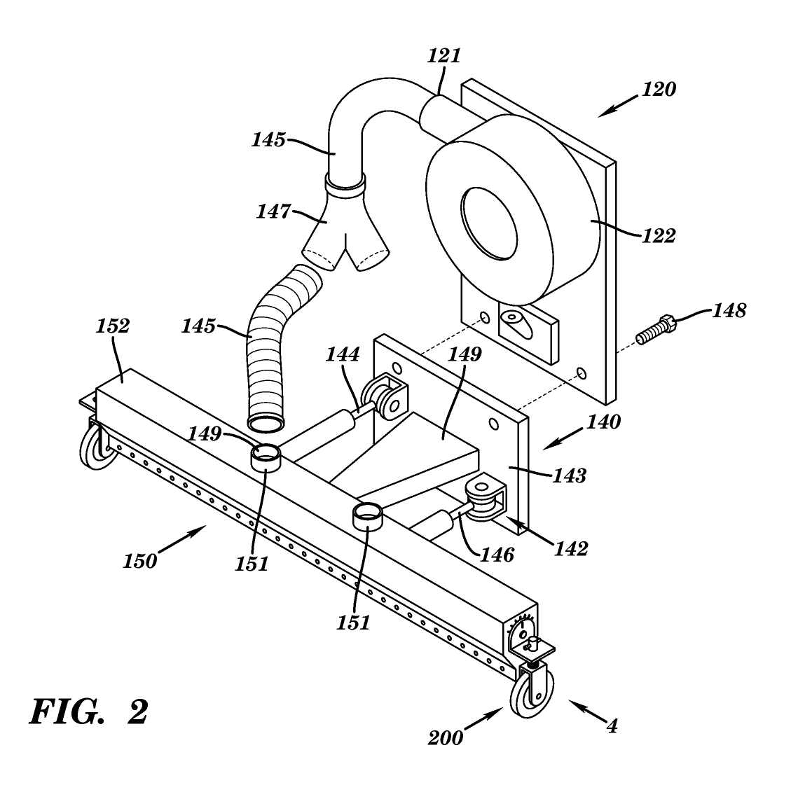

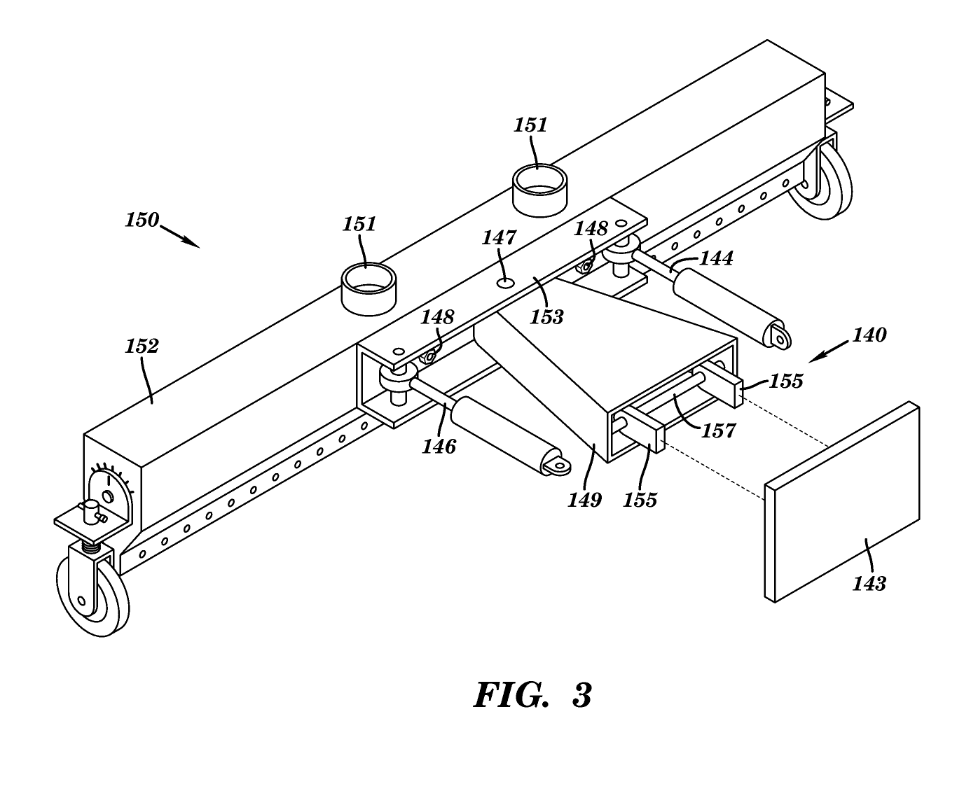

FIG. 2 is a front perspective view, partially exploded, of another aspect of the invention similar to the aspect shown in FIG. 1. For example, the aspect shown in FIG. 2 may be used when the invention is mounted to the front of a vehicle, such as, a tractor (not shown). FIG. 3 is a rear perspective view, partially exploded, of the aspect of the invention shown in FIG. 2. FIGS. 2 and 3 also depict a positioning unit 140, similar in function to positioning unit 40 shown in FIG. 1. As shown in FIGS. 2 and 3, this aspect includes a positioning unit 140 having a positioning unit frame 142 operatively connected between an air knife assembly 150 and a source of pressurized air or air supply unit 120. Positioning unit frame 142 includes a plate 143 and projection 149 mounted to plate 143. In this aspect of the invention, the air supply unit 120 may any of the units described with respect to air supply unit 20 above. For example, as shown in FIG. 2, as supply unit 120 may be centrifugal blower. Air supply unit 120 may be mounted directly to frame 142, via one or more mechanical fasteners 148, for example, screws, bolts, and the like.

As shown in FIG. 2, air supply unit 120 having an outlet 121 may be operatively connected to the air knife assembly 150 via one or more conduits or air supply lines 145. Conduits 145 may include one or more flow dividers 147 adapted to direct a flow of gas to one or more inlets 151 in air knife 150. Though flow divider 147 shown in FIG. 2 has a single inlet and two outlets, flow divider 147 may have two or more outlets as needed. For ease of illustration only a single conduit 145 is shown between divider 147 and air knife 150, where typically each outlet of divider 147 would be in fluid communicate with an inlet 151 by means of a conduit 145. According to aspects of the invention, the size and attachment features of the positioning unit frame 42 and 142 may vary according to the specific dimensions of each air supply unit 20, 120 and the vehicle to which aspect of the invention is mounted.

As shown in FIGS. 2 and 3, positioning unit 140 may also include one or more struts or supports 144, 146 adapted to attach positioning unit 140 to the pressurized air outlet assembly 150. As shown, in one aspect, struts or supports 144, 146 may comprise variable struts or supports, for example, having one or more hydraulic or pneumatic cylinders. As shown in FIG. 2, supports 144, 146 may be pivotally mounted to plate 143, for example, by bearinged tie-rod ends. As shown in FIG. 3, supports 144, 146 may be pivotally mounted to pressurized air outlet 150, for example, by bearinged tie-rod ends.

As shown in FIG. 3, pressurized air outlet assembly or air knife assembly 150 may include a main body or housing 152, one or more outlets 156, and a bracket or channel 153 mounted to housing 152 where the bracket or channel is adapted to receive supports 144 and 146, for example, by a pivotal mounting. As also shown in FIG. 3, projection 149 of positioning unit 140 may comprise a hollow housing and may be pivotally mounted to plate 143 of positioning unit 140. For example, as shown in FIG. 3, one or more projections or brackets 155 mounted to plate 144 may engage one or more rods 157, for example, pivotally engage rods 157, to allow projection 149 to deflect relative to plate 144. Projection 149 may also mount to housing 152 of air knife assembly 150, for example, pivotally mount to bracket or channel 153. Bracket 153 may be mounted to housing 152 by means of mechanical fasteners, for example, by means of two or more bolts 148. Projection 149 of positioning unit 140 may be pivotally mounted to air knife assembly 150 by means of mechanical fasteners, for example, via pin 147.

According to aspects of the invention, as shown in FIGS. 2 and 3, the manipulation of the pressurized air outlet or air knife assembly 50 may be provided by motion or position controllers, for instance, cylinders, for example, hydraulic or pneumatic cylinders. The cylinders may be associated with struts 44, 144, and/or struts 47, 146. For the sake of clarity of illustration, hydraulic or pneumatic supply and return lines or hoses are not shown in FIGS. 2 and 3. For example, vertical deflection of air knife assembly 50 may be provided via lifting/lowering cylinder assembly associated with strut 44, 144, and a rake angle of the pressurized air outlet or air knife assembly 50 may be adjusted via the rake angle cylinder assembly associated with strut 46, 146.

While the positioning system in the embodiment shown in FIGS. 2 and 3 is depicted with hydraulic or pneumatic cylinders, for example, powered by a hydraulic or pneumatic power unit (not shown), for example, mounted on frame 23 shown in FIG. 1, according to aspects of the invention, the source motive force for the positioning of the air knife 50, 150 is not limited to hydraulic or pneumatic power. Various other conventional power sources and/or power transmission devices may be used according to aspects of the invention to provide appropriate manipulation. In one aspect of the invention, hydraulic or pneumatic cylinders or any other motive force may be used to manipulate, for example, precisely adjust, the pressurized air outlet or air knife assembly 50, 150 in two or more directions, for example, four or more directions, and even any combination of six directions. This allows aspects of the invention to optimize the treating, for example, cleaning and/or drying, of various surfaces based on specific operating environments, locations, and/or conditions.

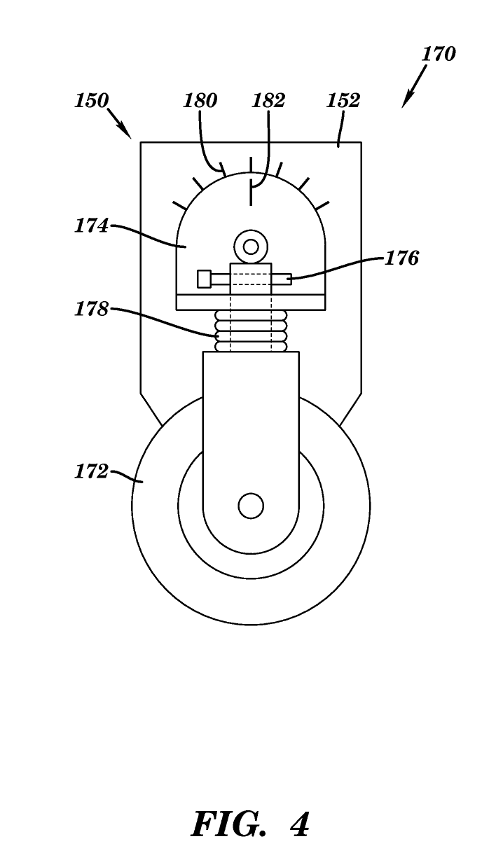

FIG. 4 is an elevation view of a detail of the aspect of the invention shown in FIG. 2 as viewed along view line 4 in FIG. 2. As detailed in FIG. 4, the position of the pressurized air outlet or air knife blade assembly 50, 150 relative to the ground may be controlled, for example, by one or more caster or wheel assemblies 170 mounted to the housing 152 of air knife assembly 50, 150. Caster assembly 170 includes a wheel 172, a caster mounting bracket 174, and pin 176, which extends through the caster bracket 174. Height adjustment of the caster assembly 170 may be provided by any conventional means, for example, by one or more spacers 178 positioned between the wheel 172 and bracket 174. In one aspect, the pitch angle of the pressurized air stream discharged by the air knife assembly 50, 150 may be determined with the aid of a series of indicia or graduation marks 180 on the air knife assembly 150, for example, on housing 152, and a match mark 182 on the caster bracket 174. Accordingly, in one aspect, housing 152 may be rotated, for example, about a horizontal axis, to vary the direction of the flow of gas from outlet 56, 156.

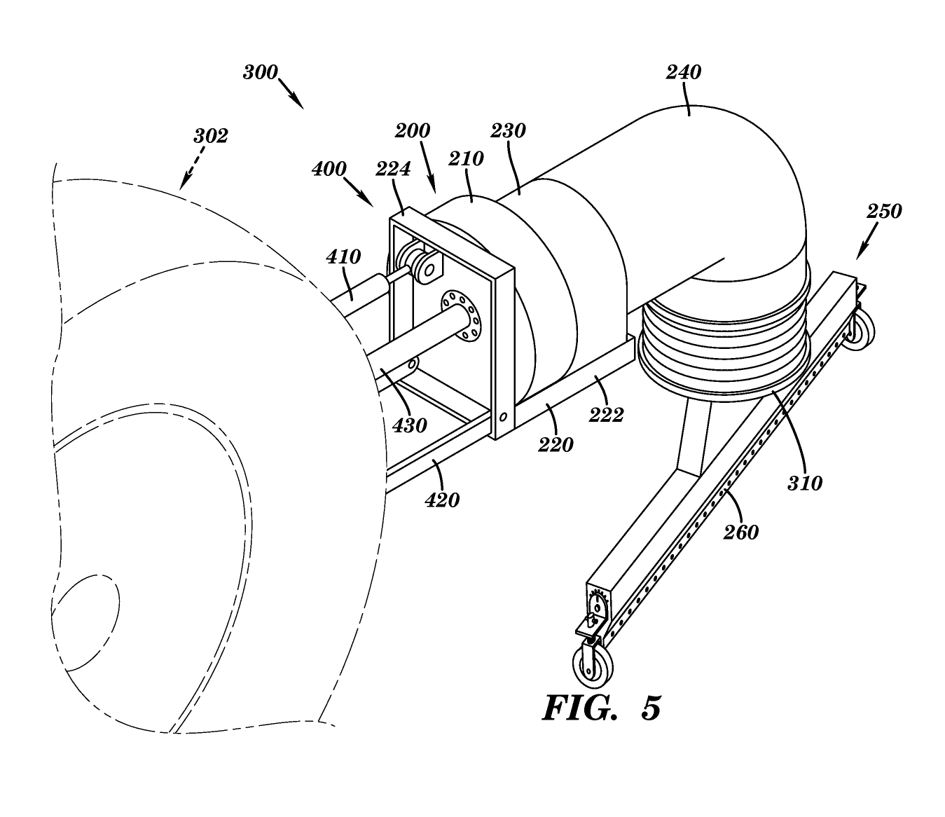

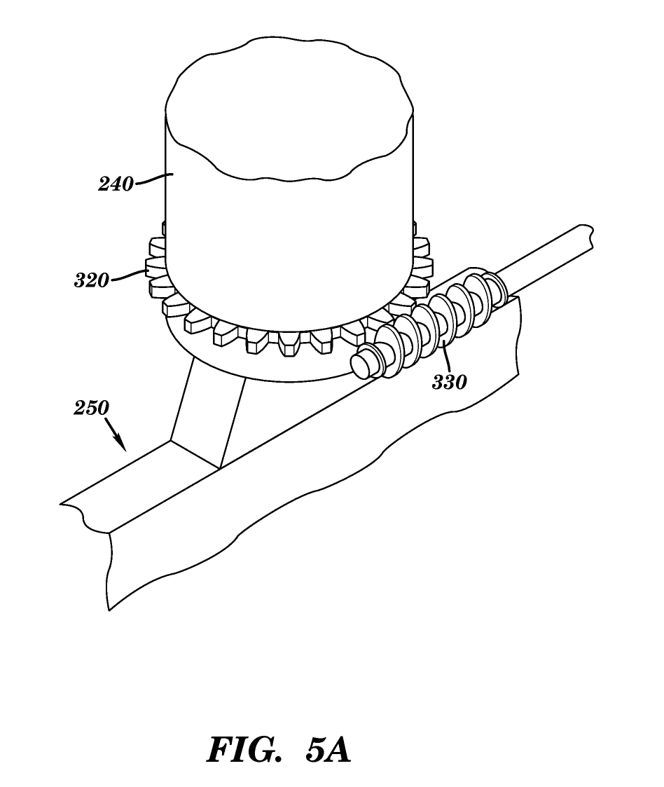

FIG. 5 is a perspective view of another aspect of the invention, for example, when an aspect of the invention is mounted to the rear of a vehicle, such as, a tractor 302 (shown in phantom). FIG. 5 illustrates an alternate mounting arrangement 300 and method for use of the surface treating system 10 shown in and described with respect to FIG. 1. In this aspect, a typical farm tractor 302 utilizing a standard three-point hitch assembly 400 is used to draw a system 200 according to aspects so the invention. Similar to the aspects of the invention described previously, system 200 includes a pressurized air outlet assembly or air knife assembly 250 and a source of pressurized air 210, for example, a fan, blower, or turbine, operatively connected to the air knife assembly 250, for example, as described above. Air knife assembly 250 may be similar in design and function to air knife assembly 50 shown in FIG. 1 and/or air knife assembly 150 shown in FIGS. 2 and 3. Air knife assembly 250 includes an air outlet 260. The source of pressurized air or air supply unit 210 of system 200 may be mounted to a frame 220 having a base 222 and an upright 224. The outlet of the source of pressurized air (not shown) may typically be directed to air knife assembly 250 via appropriately designed cavities, conduits, and/or ducting. For example, as shown in FIG. 5, system 200 may include conduits 230 and 240 sized and positioned to direct the flow of air from the source of pressurized air 210 to air knife assembly 250.

In this aspect, tractor lift arms 420 engage frame 220 and can be used to raise and lower system 200. A power take-off (PTO) shaft 430, for example from tractor 302, may be used to supply power to system 200, for example, to the air supply unit 210. The pressurized air outlet assembly or air knife pitch angle may be controlled by a top link 410. The rake angle of the pressurized air outlet or air knife assembly 250 may be controlled, for example, manually adjusted, by positioning the air knife assembly 250 by means of adjustment holes 310 in the mounting of the air knife assembly 250. In one aspect, the rake angle of the air knife 250 may be adjusted manually or automatedly as shown in FIG. 5A.

FIG. 5A is a partial perspective view of an air knife mounting according to another aspect of the invention. As shown in FIG. 5A, in one aspect, the rake angle of the air knife assembly 250 may be varied by rotating air knife assembly 250 with respect to the conduit 240 by means of a power transmission device. For example, as shown in FIG. 5A, in one aspect, air knife assembly 250 may be rotated by means of a pinion or worm gear 330 and ring or rack gear 320, where ring gear 320 is mounted to air knife assembly 250. According to this aspect of the invention, the rotation of worm gear 330, for example, manually or automatedly, rotates ring gear 320 and, accordingly, air knife assembly 250, as desired. Caster assembly 520 may control the position of the pressurized air outlet or air knife blade 260 relative to the ground, which may be similar in operation and function to caster assembly 170 shown in FIG. 4.

In one aspect of the invention, for example, for the aspect shown in FIG. 5 or any other aspect disclosed herein, a round tubular air knife (not shown) may be used for air knife assemblies 50, 150, and/or 250. For example, a round tubular air knife may be desirable when treating, for instance, softer turf surfaces. According to this aspect of the invention, a round air knife may be provided by an air knife housing comprising an elongated circular cylindrical housing, such as, a tube, having one or more slots or holes arranged in the direction of elongation. For example, a machined slot may be provided down the axial plane of the tube, with adjusting screws similar to screws 45 shown in FIG. 1 to control the width of the slot. Similar increases in both temperature and pressure can be realized using the round tube air knife aspect of the invention.

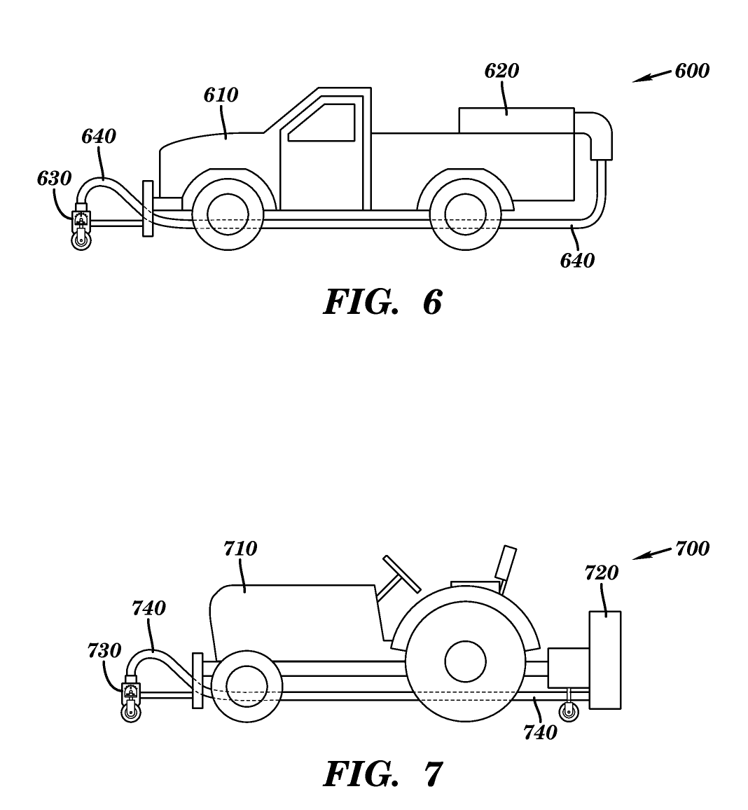

FIGS. 6 through 12 are schematic elevation views illustrating various combinations of aspects of the invention and vehicles to which aspects may be mounted. FIG. 6 is a schematic illustration of arrangement 600 where aspects of the invention are mounted on a truck 610, for example, a pickup truck. As shown in FIG. 6, a source of pressurized air 620 may be mounted in the bed the truck 610 and an air knife assembly 630 may be mounted to the front of the truck. Appropriate ducting and/or conduit 640 may be used to operatively connect the outlet of the source of pressurized air 620 to the inlet of the air knife assembly 630.

FIG. 7 is a schematic illustration of arrangement 700 where aspects of the invention are mounted on a tractor 710, for example, a farm tractor. As shown in FIG. 7, a source of pressurized air 720 may be mounted to the rear of tractor 710, for example, by means of a three-point hitch assembly, and the air knife assembly 730 may be mounted to the front of the tractor 710. Appropriate ducting and/or conduit 740 may be used to operatively connect the outlet of the source of pressurized air 720 to the inlet of the air knife assembly 730.

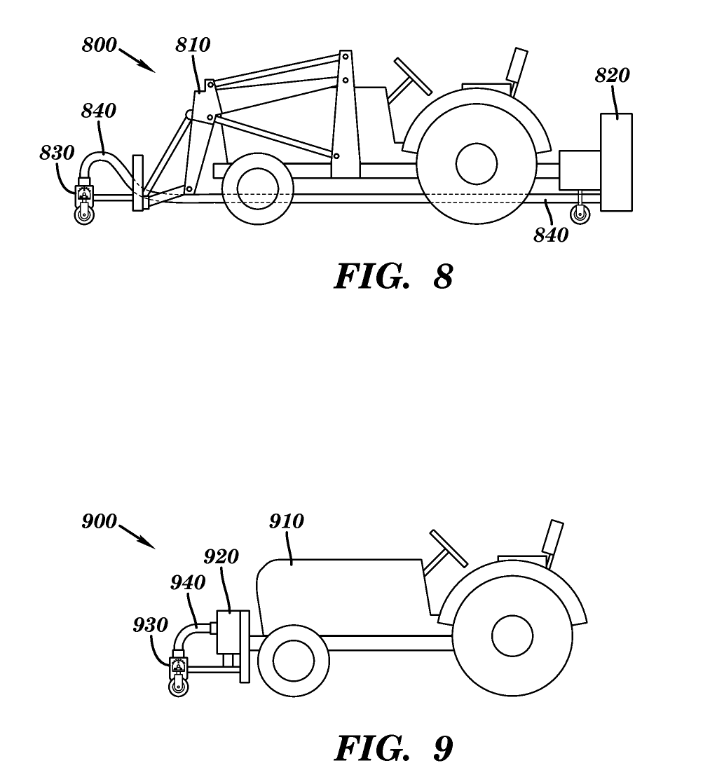

FIG. 8 is a schematic illustration of arrangement 800, similar to FIG. 7, where aspects of the invention are mounted on a tractor 810, for example, a tractor having front-end loader assembly. As shown in FIG. 8, a source of pressurized air 820 may be mounted to the rear of tractor 810, for example, by means of a three-point hitch assembly, and an air knife assembly 830 may be mounted to the front of the tractor 810, for example, mounted to the front-end loader assembly. Appropriate ducting and/or conduit 840 may be used to operatively connect the outlet of the source of pressurized air 820 to the inlet of the air knife assembly 830.

FIG. 9 is a schematic illustration of arrangement 900, similar to FIGS. 7 and 8, where aspects of the invention are mounted on a tractor 910, for example, a tractor having a hydraulic motor. As shown in FIG. 9, a source of pressurized air 920 may be mounted to the front of tractor 910, for example, and powered by the hydraulic motor (not shown), and the air knife assembly 930 may be mounted to the front of the tractor 910, for example, mounted in front of the source of pressurize air 920. Appropriate ducting and/or conduit 940 may be used to operatively connect the outlet of the source of pressurized air 920 to the inlet of the air knife assembly 930.

FIG. 10 is a schematic illustration of arrangement 1000 where aspects of the invention are mounted on a utility vehicle (UTV) or an all-terrain vehicle (ATV) 1010. As shown in FIG. 10, a source of pressurized air 1020 may be mounted in the bed of the vehicle 1010 and the air knife assembly 1030 may be mounted to the front of the vehicle. Appropriate ducting and/or conduit 1040 may be used to operatively connect the outlet of the source of pressurized air 1020 to the inlet of the air knife assembly 1030.

FIG. 11 is a schematic illustration of arrangement 1100 where aspects of the invention are mounted on a skid loader or skid steer 1110, for example, having a front-end loader assembly. As shown in FIG. 11, a source of pressurized air 1120 may be mounted in the bucket of the front-end loader assembly of the skid steer 1110 and the air knife assembly 1130 may be mounted in the bucket of the front-end loader assembly of the skid steer 1110. Appropriate ducting and/or conduit 1140 may be used to operatively connect the outlet of the source of pressurized air 1120 to the inlet of the air knife assembly 1130.

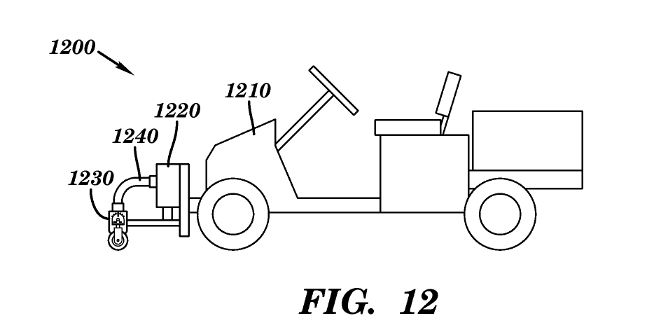

FIG. 12 is a schematic illustration of arrangement 1200 where aspects of the invention are mounted on a mower 1210, for example, a commercial-grade mower. As shown in FIG. 12, a source of pressurized air 1220 may be mounted to the front (or rear) of the mower 1210 and the air knife assembly 1230 may be mounted to the front (or rear) of the mower 1210. Appropriate ducting and/or conduit 1240 may be used to operatively connect the outlet of the source of pressurized air 1220 to the inlet of the air knife assembly 1230.

FIG. 13 is a perspective view of another aspect of the invention that can be used for “walk behind” applications, for example, for driveways, sidewalks, and/or sporting surfaces. As shown in FIG. 13, according to this aspect, a portable system 1300 is provided having a source of pressurized air 1320 and an air knife assembly 1330 may be mounted to a frame 1325. System or device 1300 may typically have one or more handle bars 1305 mounted to frame 1325. Appropriate ducting and/or conduit 1340 may be used to operatively connect the outlet of the source of pressurized air 1320 to the inlet of the air knife assembly 1330. In this embodiment, the source of pressurized air 1320 may be a blower unit, for example, a centrifugal blower unit, that supplies pressurized air to conduit 1340. The air knife assembly 1330 may be operatively connected to the outlet of the source of pressurized air 1320, for example, mounted directly to the output nozzle of the blower. A sprocket or ring gear may control the rake angle of the air knife assembly 1330 1331 mounted to the air knife assembly 1330. The ring gear 1331 may be deflected by a pinion or worm gear 1332, for example, manually, by rotating handle 1333 operatively connected to worm gear 1332, or automatedly, by actuating worm gear 1334 by conventional automated means. The position of the air knife blade assembly 1330 relative to the ground may be controlled by the rollers 1335, and a pin which extends through the roller height adjustment and roller bracket, for example, as disclosed in and described with respect to FIG. 4, or its equivalent.

Systems, devices, and methods for treating target surfaces, for example, roadways, runways, and even sidewalks, are provided. These systems, devices, and methods, which are typically portable, provide means for treating a target surface, for example, heating, cleaning, clearing, and/or drying the target surface, that overcome the limitations of the prior art. Aspects of the invention are adapted to treat a wide range of surfaces, including roadways, runways, racing surfaces (for example, both paved or aggregate surfaces and/or ice surfaces), athletic fields, athletic courts, skating rinks/tracks, sidewalks, driveways, shipboard decks, garages, factory floors, and clean rooms, among other uses.

While the present invention has been described in detail, numerous variations, substitutions of materials, and/or modifications to design features may be made without departing from the intent or spirit of the unique and improved aspects of the claims made below. Accordingly, it is to be understood that the present invention has been described by way of illustration, and not by limitation.

1. A portable system for directing a flow of pressurized air upon a surface, the portable system comprising:
a source of pressurized air; and
a pressurized air outlet operatively connected to the source of pressurized air, the pressurized air outlet adapted to direct a flow of the pressurized air upon the surface while the pressurized air outlet translates over the surface.

2. The system as recited in claim 1, wherein the system further comprises a plenum having an inlet operatively connected to the source of pressurized air, the plenum in fluid communication with the pressurized air outlet.

3. The system as recited in claim 1, wherein the system further comprises a conduit having a first end operatively connected to the source of pressurized air and a second end operatively connected to the pressurized air outlet.

4. The system as recited in claim 1, wherein the system further comprises a mechanism adapted to vary the orientation of the pressurized air outlet.

5. The system as recited in claim 1, wherein the source of pressurized air comprises at least one of a fan, a blower, and a turbine.

6. The system as recited in claim 1, wherein the pressurized air outlet comprises an air knife.

7. The system as recited in claim 1, wherein the pressurized air outlet comprises an adjustable outlet.

8. The system as recited in claim 1, wherein the system further comprises a means for moving the portable system.

9. The system as recited in claim 1, wherein the system is adapted for treating the surface.

10. The system as recited in claim 1, wherein the system further comprises a vehicle adapted to transport the system.

11. A method of treating a surface with pressurized air, the method comprising:
directing a flow of pressured air from a pressurized air outlet while the pressurized air outlet is translated over the surface.

12. The method as recited in claim 11, wherein treating comprises one or more of cleaning and drying.

13. The method as recited in claim 11, wherein the method further comprises pressurizing air to provide the pressurized air.

14. The method as recited in claim 11, wherein the method further comprises varying a dimension of the pressurized air outlet to vary one of the velocity, temperature and pressure of the pressurized air.

15. The method as recited in claim 11, wherein the method further comprises varying the orientation of the pressurized air outlet.

16. A portable surface treating system comprising:
a source of pressurized air mounted to a frame, the source having an outlet discharging pressured air;
at least one conduit having a first end operatively connected to the outlet and a second end;
a pressurized air outlet assembly having an inlet operatively connected to the second end of the at least one conduit source of pressurized air, a plenum in fluid communication with the inlet, and at least one outlet in fluid communion with the plenum adapted to discharge a flow of pressurized air upon the surface to displace any undesirable material from the surface; and
a mechanism adapted to vary an orientation of the pressurized outlet assembly.

17. The system as recited in claim 16, wherein the system further comprises a mechanism adapted to vary a size of the at least one outlet.

18. The system as recited in claim 16, wherein the source of pressurized air comprises at least one of a fan, a blower, and a turbine.

19. The system as recited in claim 16, wherein the system further comprises a handle bar mounted to the frame.

20. The system as recited in claim 16, wherein treating comprises at least one cleaning, clearing, drying, and heating the surface.
